(19) United States
(12) Patent Application Publication
(10) Pub. No.: US 2012/0023450 A1
(43) Pub. Date: Jan. 26, 2012

(54) USER INTERFACE DEVICE AND USER INTERFACE METHOD

(75) Inventors: Ryuichiro Noto, Chiba (JP); Rikizo Tabe, Tokyo (JP); Katsuhiko Nunokawa, Kanagawa (JP); Takeshi Yamamoto, Tokyo (JP)

(73) Assignee: Sony Corporation, Tokyo (JP)

(21) Appl. No.: 13/165,905

(22) Filed: Jun. 22, 2011

(30) Foreign Application Priority Data
Jul. 23, 2010 (JP) 2010-165949

(51) Int. Cl. G06F 3/048

(52) U.S. Cl. 715/825

(57) ABSTRACT

A user interface device includes: a display unit on which plural buttons are displayed; a touch panel integrally formed with the display unit and detecting input in plural input areas corresponding to respective display areas of the plural buttons; a pressure detection means for detecting water pressure; and a layout control means for changing a layout of the buttons and the input areas so as to reduce the number of the buttons and the input areas corresponding to the buttons in accordance with detected magnitude of water pressure when the water pressure detected by the pressure detection means is equal to or higher than a previously set threshold value.

### FIELD

The present disclosure relates to a user interface device and a user interface method. In particular, the present disclosure relates to a user interface device and a user interface method responding to environmental change under water, at high altitude or the like.

### BACKGROUND

As a device used both as a display device and an input device, there is a so-called touch panel (touch screen) in which a capacitance type or a resistance-film type (pressure sensitive) touch sensor is provided on a surface of a display unit such as a liquid crystal display. The touch panel is used in various electronic apparatuses such as a personal computer, a digital still camera, a digital video camera, a smartphone, a portable music player and game machine. When using the touch panel, information can be inputted to the apparatuses by touching the screen and the user can deal with electronic apparatuses easily and instinctively. In recent years, a user interface for electronic apparatuses is shifting from physical buttons, so-called hard buttons which have been heretofore used to so-called soft buttons using the touch panel.

Normally, plural buttons are displayed on a display screen of the display unit in the touch panel. A user touches a position where an arbitrary button exists in the plural buttons by a finger or a stick for input (so-called a touch pen) to thereby perform input.

However, there is a case where it is difficult to perform the input accurately because displacement is generated between a button desired by the user and the position touched by the use's finger and the like on the touch panel. For example, when plural buttons which can be selected by the user are displayed close to one another on the screen of the touch panel, there is a case where a button different from a button intended by the user is selected due to factors such as a holding manner of the touch panel or the length of a user's nail. There is also a case where it is difficult to perform accurate input as the position of a finger and the like is displaced due to environment where the user performs input to the touch panel. In such cases, processing intended by the user is not performed and processing not intended by the user is actually performed, which gives the user uncomfortable feeling.

Considering the above, there is proposed a technique of extending the size of a selected virtual button in accordance with magnitude of pressure to the touch panel by contact of a finger to thereby prevent generation of a function not intended by the user (JP-A-2008-305174 (Patent Document 1).

### SUMMARY

The change of the virtual button by an information processing apparatus described in Patent Document 1 is the change of the size of the virtual button in accordance with pressure due to pressing by a human finger. When the finger touches the touch panel and a contact surface is extended or a position of the contact surface is displaced, the contact surface can be included within the virtual button by extending the size of the virtual button. Therefore, the technique effectively functions with respect to the displacement of the finger's position after the finger touches an arbitrary position on the touch panel.

On the other hand, there is the case where it is difficult to perform accurate input to the touch panel by the user due to environment. As the case where it is difficult to perform accurate input due to environment, namely, as the case where it is difficult that the finger touches the accurate position on the touch panel, for example, environment under water can be cited.

A digital still camera and a digital video camera (hereinafter referred to as underwater digital cameras) capable of taking images even under water such as sea have been heretofore developed. There are many underwater digital cameras applying the touch panel as a display means and an input means. However, the type, arrangement, the size and so on of buttons displayed on the touch panels mounted on the underwater digital cameras are previously fixed by manufacturers.

There exists a device simplifying the arrangement and so on of buttons on the touch panel from the normal arrangement for realizing so-called easy operation for beginners, however, switching between “the normal arrangement” and “the easy operation” is generally performed by user's hand.

There is a case where it is difficult to move fingers freely underwater due to effects of water pressure and waves. There is also a case where the view is largely obstructed as compared on land. Therefore, there is a case where it is difficult to touch the intended position accurately by a finger and so on and difficult to perform the intended input when the user tries to perform input with respect to the touch panel under water.

Moreover, it is necessary to use an oxygen cylinder when deeply dived or dived for a long period of time as human beings do not breathe under water, therefore, the user is likely to be in psychologically unstable state as compared on land. There is a case where it is difficult to touch the accurate position on the touch panel by the finger and so on also by the psychological unstable state.

Similarly, there is a case where it is difficult to perform accurate input with respect to the touch panel in high-altitude places such as high mountains due to effects of wind and the like. Additionally, there is a case where it is difficult to perform accurate input as air pressure is lower in the high-altitude places than in flat land, which causes the psychologically unstable state in the same manner asunder water. The technique described in Patent Document 1 does not respond to the above situations.

In view of the above, it is desirable to provide a user interface device and a user interface method capable of performing accurate input by changing a layout of buttons and input areas corresponding to the buttons in accordance with environment such as under water or at high altitudes.

An embodiment of the present disclosure is directed to a user interface device including a display unit on which plural buttons are displayed, a touch panel integrally formed with the display unit and detecting input in plural input areas corresponding to respective display areas of the plural buttons, a pressure detection means for detecting water pressure and a layout control means for changing a layout of the buttons and the input areas so as to reduce the number of the buttons and the input areas corresponding to the buttons in accordance with detected magnitude of water pressure when the water pressure detected by the pressure detection means is equal to or higher than a previously set threshold value.

Another embodiment of the present disclosure is directed to a user interface device including a display unit on which plural buttons are displayed, a touch panel integrally formed with the display unit and detecting input in plural input areas corresponding to respective display areas of the plural buttons, a pressure detection means for detecting air pressure and a layout control means for changing a layout of the buttons and the input areas so as to reduce the number of the buttons and the input areas corresponding to the buttons in accordance with detected magnitude of air pressure when the air pressure detected by the pressure detection means is equal to or lower than a previously set threshold value.

Still another embodiment of the present disclosure is directed to a user interface method including a displaying plural buttons on a display unit, setting positions of the plural buttons displayed on the display unit as well as setting plural areas corresponding to respective display areas of the plural buttons as input areas on a touch panel integrally formed with the display unit and detecting input, detecting water pressure, and changing a layout of the buttons and the input areas so as to reduce the number of the buttons and the input areas corresponding to the buttons in accordance with detected magnitude of water pressure when the water pressure detected by the step of detecting pressure is equal to or higher than a previously set threshold value.

Yet another embodiment of the present disclosure is directed to a user interface method including displaying plural buttons on a display unit, setting positions of the plural buttons displayed on the display unit as well as setting plural areas corresponding to respective display areas of the plural buttons as input areas on a touch panel integrally formed with the display unit and detecting input, detecting air pressure, changing a layout of the buttons and the input areas so as to reduce the number of the buttons and the input areas corresponding to the buttons in accordance with detected magnitude of air pressure when the air pressure detected by the step of detecting pressure is equal to or lower than a previously set threshold value.

According to the embodiments of the present disclosure, the user can perform accurate input easily even when it is difficult to perform accurate input due to environmental effects such as under water or at high altitude by changing the layout of buttons and input areas on the touch panel in accordance with variation of pressure.

### BRIEF DESCRIPTION OF THE DRAWINGS

FIG. 1 is a block diagram showing a schematic configuration of a user interface device according to an embodiment of the present disclosure;

FIGS. 2A to 2C are views showing layouts of buttons and input areas;

FIGS. 3A to 3C are views showing layouts in a case where the number of buttons and input areas is reduced to one;

FIGS. 4A to 4C are views showing other examples of layouts of buttons and input areas;

FIG. 5 is a diagram showing a schematic configuration of an imaging apparatus to which the user interface device according to an embodiment of the present disclosure is applied;

FIG. 6 is a flowchart showing the processing flow according to a first embodiment of the present disclosure;

FIGS. 7A to 7D are views showing layouts of buttons and input areas in the imaging apparatus to which the user interface device is applied; and

FIG. 8 is a flowchart showing the processing flow according to a second embodiment of the present disclosure.

### DETAILED DESCRIPTION

Hereinafter, embodiments of the present disclosure will be explained with reference to the drawings. The explanation will be made in the following order.

### 1. First Embodiment

1-1. Configuration of a User Interface Device

1-2. Configuration of an Imaging Apparatus to which the User Interface Device is Applied

1-3. Operation of the User Interface Device in the Imaging Apparatus

### 2. Second Embodiment

2-1. Operation of the User Interface Device in the Imaging Device

3. Modification Example.

### <1. First Embodiment>

### [1-1. Configuration of a User Interface Device]

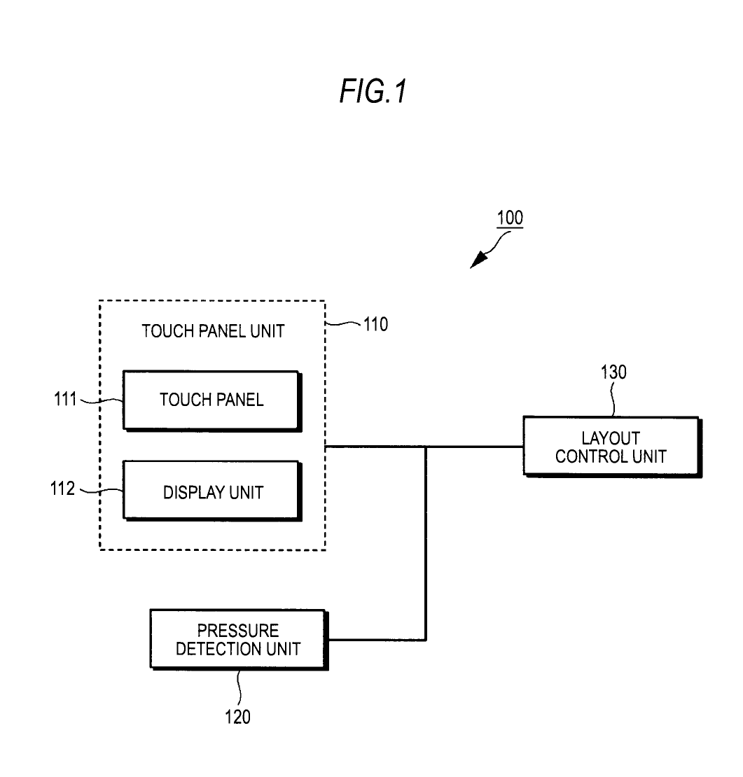

FIG. 1 is a schematic configuration diagram of a user interface device 100 according to an embodiment of the present disclosure. The user interface device 100 includes a touch panel unit 110, a pressure detection unit 120 and a layout control unit 130. The touch panel unit 110 includes a touch panel 111 and a display unit 112.

The touch panel unit 110 has a structure in which the touch panel 111 and the display unit 112 are integrally formed, functioning as a display means displaying images, video and buttons for input as well as functioning as an input means. The touch panel 111 is a so-called resistance-film type touch panel, in which an upper electrode plate and a lower electrode plate are opposed to each other and a transparent conductive film and a spacer are provided between the upper electrode plate and the lower electrode plate. When the resistance-film type touch panel is pressed from the upper-electrode plate side by a finger, a dedicated touch pen or the like, the upper electrode plate sags at a position where the spacer does not exist and touches the lower electrode plate. Accordingly, the pressed position is detected and outputted as an operation signal.

The display unit 112 is a display device such as a LCD (Liquid Crystal Display) or an organic EL (Electro Luminescence) display. The touch panel 111 is adhered closely to the display unit 112 on a display screen 112A side to form the touch panel unit 110.

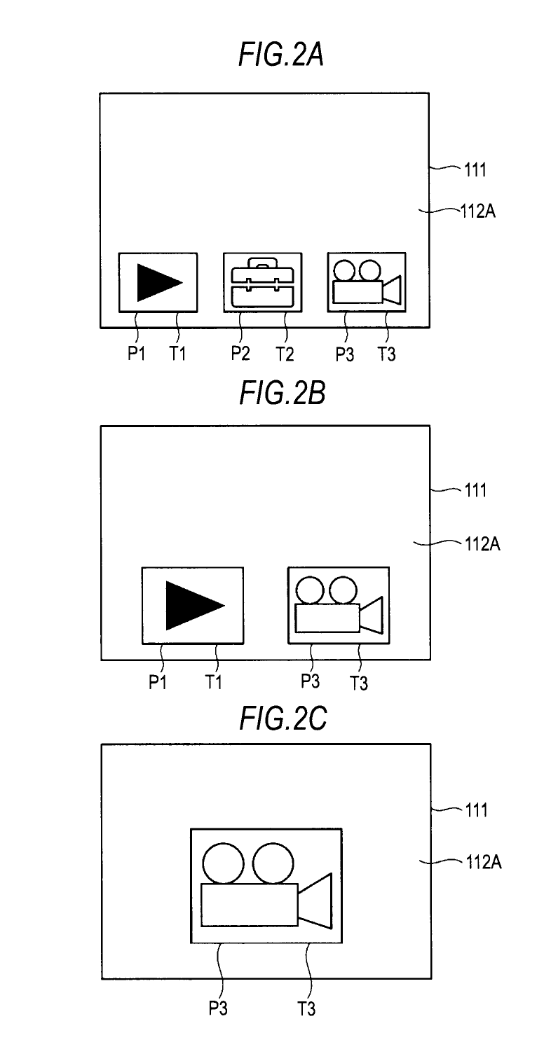

As shown in FIG. 2A, the touch panel 111 is provided with plural (three in FIG. 2A) input areas T1, T2 and T3 by demarcating areas by demarcation lines. Buttons P1, P2 and P3 are displayed on the display screen 112A of the display unit 112 so as to correspond to respective input areas. When the finger of the user or the touch pen touches the input area corresponding to the button, processing or operation corresponding to the input area is performed in an apparatus having the user interface device 100. The buttons are displayed as icons of characters, graphics indicating processing to be executed by the input with respect to the input areas. The demarcation lines forming areas are not normally displayed and are not recognized by the user.

The pressure detection unit 120 is a pressure sensor capable of measuring water pressure and air pressure such as a diffusion-type pressure sensor using piezoresistance effect. For example, when the apparatus having the user interface device 100 is used under water, the pressure detection unit 120 detects water pressure and outputs a value of the water pressure to the layout control unit 130.

The layout control unit 130 performs processing of changing the number, the position and the size of buttons displayed on the display unit 112 and the input areas corresponding to the buttons in the touch panel 111 based on the pressure value outputted from the pressure detection unit 120.

The layout control unit 130 includes, for example, a CPU (Central Processing Unit), a RAM (Random Access Memory), a ROM (Read Only Memory) and so on. Programs and so on read and operated by the CPU are stored in the ROM. The RAM is used as a work memory of the CPU. When the CPU performs processing in accordance with programs stored in the ROM, functions as the layout control unit 130 are executed.

Hereinafter, processing of changing the layout of buttons displayed on the display screen 112A of the touch panel unit 110 and input areas corresponding to display areas of the buttons in the touch panel 111 will be explained. FIGS. 2A to 2C are views showing layout examples of the buttons and the input areas. In FIGS. 2A to 2C, the button and the input area are arranged with approximately the same size and at approximately the same position.

In the embodiments of the present disclosure, the number, the position and the size of the buttons and of the input areas are changed based on a pressure value detected by the pressure detection unit 120. For example, a state shown in FIG. 2A is a normal (default) state, in which buttons P1, P2 and P3 and input areas T1, T2 and T3 are horizontally arranged at a lower side of the display unit 112. When the pressure value becomes equal to or higher than a threshold value A as a result of comparing the pressure value obtained by the pressure detection unit 120 with the threshold value A, the layout of buttons and input areas is changed into the one shown by FIG. 2B. In the layout of FIG. 2B, the number of buttons and input areas is reduced to two respectively, and the buttons P1, P3 and the input areas T1, T3 are arranged. The sizes of the buttons P1, P3 and the input areas T1, T3 are extended. Moreover, positions are adjusted so that the buttons P1, P3 are arranged within the surface screen in a balanced manner. The threshold value A is a threshold value to be a reference at which the layout is changed into the layout in which the number of buttons and input areas is reduced, which corresponds to a first threshold value in the embodiment.

Additionally, when the pressure value is equal to or higher than a threshold value B which is set to be higher than the threshold value A, the layout of buttons and input areas is changed into the one shown by FIG. 2C. In the layout of FIG. 2C, the number of buttons and input areas is further reduced, and the button P3 and the input area T3 are merely arranged. The sizes of the button P3 and the input area T3 are further extended as compared with the layout shown in FIG. 2B. Moreover, positions of the button P3 and the input area T3 are adjusted so that they are arranged at approximately the center in the horizontal direction of the display screen 112A. The threshold value B is a threshold value to be a reference at which the layout is changed into the layout in which the number of buttons and input areas is reduced to one, which corresponds to a second threshold value in the embodiment.

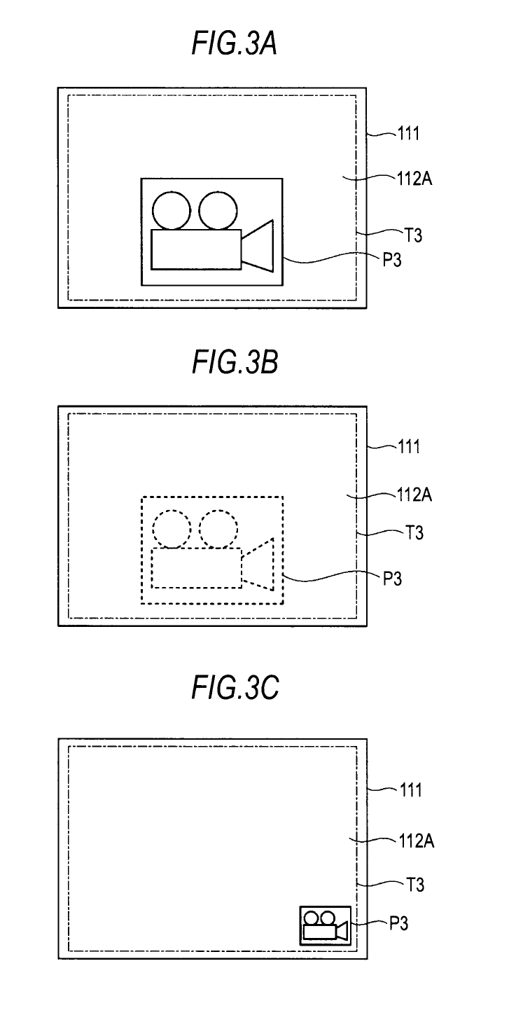

When the number of buttons and input areas is reduced to one as shown in FIG. 2C, it is not necessary to visually check to which button the input is performed at the time of input. Therefore, the size of the input area T3 can be made to be approximately the same as the size of the display screen 112A. In FIG. 3A, the input area T3 corresponding to the button P3 is shown by a dash-dotted line. Accordingly, the input is performed wherever the user touches on the display screen 112A, therefore, input using the touch panel unit 110 becomes easier.

When the size of the input area T3 is approximately the same as the size of display screen 112A as described above, input can be made wherever the user touches on the display screen 112A, therefore, it is also preferable that the button is not displayed. In order to prevent the user from not knowing which processing will be performed by the input when the button is not displayed, the button P3 can be displayed in a half-transparent state as shown in FIG. 3B. It is also preferable that the button 23 is displayed at a corner of the display screen 112A with a small size as shown in FIG. 3C.

As described above, the layout of buttons and input areas is changed in accordance with the pressure value detected by the pressure detection unit 120 in the embodiment of the present disclosure. When the layout is changed, layouts of buttons and input areas are previously held in plural ROMs and so on as a preset and a proper layout is selected from the plural layouts based on the determination result of comparison between the pressure value and the threshold value. Then, the number, the display position and the size of buttons and input areas are set anew by applying the layout, thereby changing the layout.

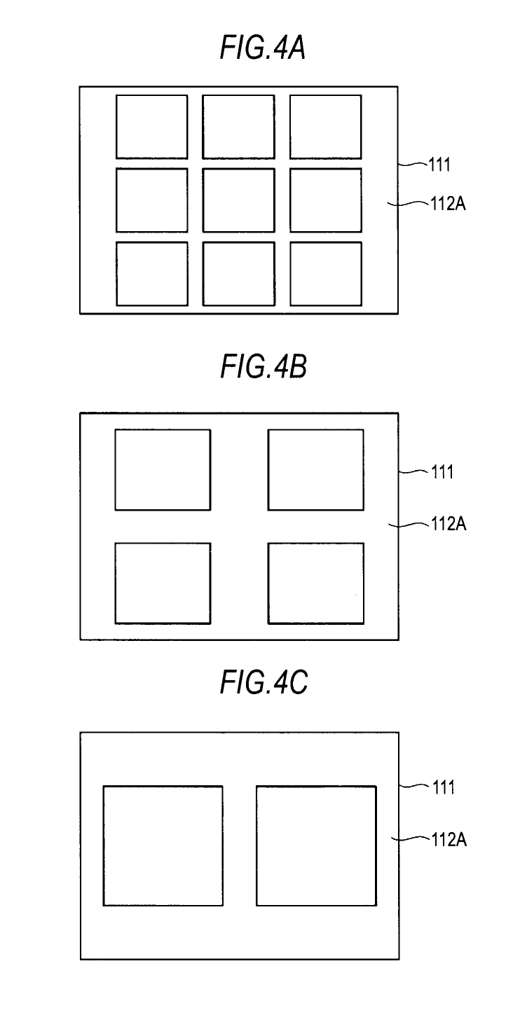

The layouts shown in FIGS. 2A to 2C are just examples and other various types of layouts can be applied. For example, the total of nine buttons and input areas of 3×3 in vertical and horizontal directions are arranged in default as shown in FIG. 4A. When the pressure value becomes equal to or higher than the threshold value A, the layout is changed so that the number of buttons and input areas will be four in total of 2×2 in vertical and horizontal directions as shown in FIG. 4B. Moreover, when the pressure value becomes equal to or higher than the threshold value B, the layout is changed so that the number of buttons and input areas will be two in total of 1×2 in vertical and horizontal directions as shown in FIG. 4C. The layout of buttons and input areas can apply various combinations. The layout change is performed in three stages both in FIGS. 2A to 2C and FIGS. 4A to 4C, however, it is not limited to three stages and it is also preferable that more threshold values are set and the layout is changed by being divided into more stages.

[1-2. Configuration of an Imaging Apparatus to which the User Interface Device is Applied]

Next, a case in which the user interface device 100 is applied to an imaging apparatus 200 capable of taking images under water will be explained as a specific use example of the above user interface device 100.

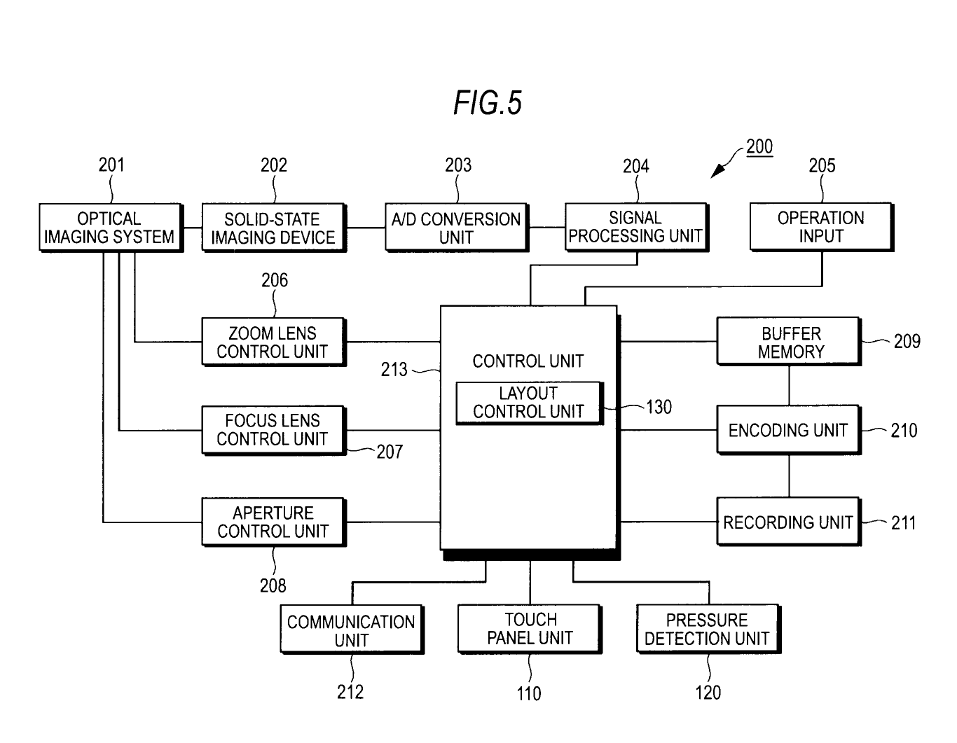

FIG. 5 is a block diagram showing a schematic configuration of the imaging apparatus 200. The imaging apparatus 200 includes an optical imaging system 201, a solid-state imaging device 202, an A/D conversion unit 203, a signal processing unit 204, an operation input 205, a zoom lens control unit 206, a focus lens control unit 207, an aperture control unit 208, a buffer memory 209, an encoding unit 210, a recording unit 211, a communication unit 212, the touch panel unit 110, the pressure detection unit 120, a control unit 213 and the layout control unit 130. The touch panel unit 110, the pressure detection unit 120 and the layout control unit 130 are the same as the above, which compose the user interface device in the imaging apparatus 200. The touch panel unit 110 functions as an input means different from the operation input unit 105 as well as functions as a display means performing display of taken still images, reproduction of moving images, display of through images at the time of imaging, display of various setting screens and so on.

The imaging apparatus 200 has both functions of a digital still camera and a digital video camera, which is capable of taking still images in a still image mode and taking moving images in a moving image mode. The imaging apparatus 200 has waterproof property by housing the above components in, for example, a waterproof housing (not shown), which is capable of taking images under water.

The optical imaging system 210 includes, for example, an imaging lens, a zoom lens, a focus lens, an aperture and the like, which allows an optical image of a subject to be incident. The optical image of the subject obtained through the optical imaging system 201 is imaged on the solid-state imaging device 202 as an imaging device. As the solid-state imaging device 202, a CCD (Charge Coupled Device), a CMOS (Complementary Metal Oxide Semiconductor) and so on are used.

The solid-state imaging device 202 converts the imaged optical image into the charge amount by photoelectric conversion and outputs an analog imaging signal. The analog imaging signal outputted from the solid-state imaging device 202 is supplied to the A/D conversion unit 203. The A/D conversion unit 203 converts the analog imaging signal supplied from the solid-state imaging device 202 into a digital imaging signal and outputs the signal to the signal processing unit 204.

The signal processing unit 204 converts the digital imaging signal outputted from the A/D conversion unit 203 into image data including, for example, a luminance signal and a color difference signal, outputting the image data to the control unit 213. The zoom lens control unit 206, the focus lens control unit 207 and the aperture control unit 208 respectively control the zoom lens, the focus lens, the aperture and so on included in the optical imaging system 201 in accordance with control signals from the control unit 213.

The operation input unit 205 includes various buttons such as a power button for inputting power of the imaging apparatus 200 and a release button, levers, dials and so on. When an operation input is performed, the operation input unit 205 generates an operation signal corresponding to the operation and outputs the signal to the control unit 213. When the release button of the operation input unit 205 is pressed by the user, recording of still images and moving images, that is, the imaging is performed.

The buffer memory 209 is a storage medium including a non-volatile memory, for example, a DRAM (Dynamic Random Access Memory), which temporarily stores image data to which given processing is performed by the signal processing unit 204.

The encoding unit 210 supplies image data supplied from the buffer memory 209 to the recording unit 211 by encoding the data into, for example, JPEG (Joint Photographic Experts Group) data in the case of the still image mode. In the case of the moving image mode, the data is encoded into MPEG (Moving Picture Experts Group) data and the like. The recording unit 211 is a large-capacity recording medium including, for example, a hard disk, a memory stick (Trademark of Sony Corporation), a SD memory card and so on, which stores still images and moving images taken by the imaging apparatus 200.

The communication unit 212 is an interface for transmitting and receiving various data to and from other apparatuses, for example, a personal computer and so on. Both wired and wireless systems can be used as a communication system, and connection is performed by a USB (Universal Serial Bus) cable and so on in the case of the wired system. In the case of the wireless system, Bluetooth (Trademark), a close-proximity wireless transfer technology Transfer Jet (Trademark of Sony Corporation) and so on can be used.

The control unit 213 includes a CPU, a RAM, a ROM and the like. The ROM stores programs and so on read and operated by the CPU. The RAM is used as a work memory of the CPU. The CPU controls the entire imaging apparatus 200 by executing various processing and issuing commands in accordance with programs stored in the ROM. The control unit 213 further executes a given program to thereby function as the layout control unit 130.

Here, operation of the above imaging apparatus 200 will be roughly explained. A signal received by the optical imaging system 201 and photoelectrically converted is converted into a digital signal by the A/D converting unit 203 and supplied to the signal processing unit 204. In the signal processing unit 204, image data receives processing of image-quality correction and supplied to the control unit 213 as image data of camera through images. The image data is outputted to the buffer memory 209 and stored therein. The image data further receives given processing in the control unit 213 and supplied to the touch panel unit 110, then, displayed as the through image on the display unit 112 including the touch panel unit 110. As the result, the user can perform field angle adjustment while seeing the through image displayed on the display unit 112 of the touch panel unit 110.

When the release button of the operation input unit 105 is pressed down, image data is transmitted from the buffer memory 209 to the encoding unit 210, where the data is compressed and encoded, then, the encoded data is finally recorded in the recording unit 211 as images or video.

### [1-3. Operation of the User Interface Device in the Imaging Apparatus]

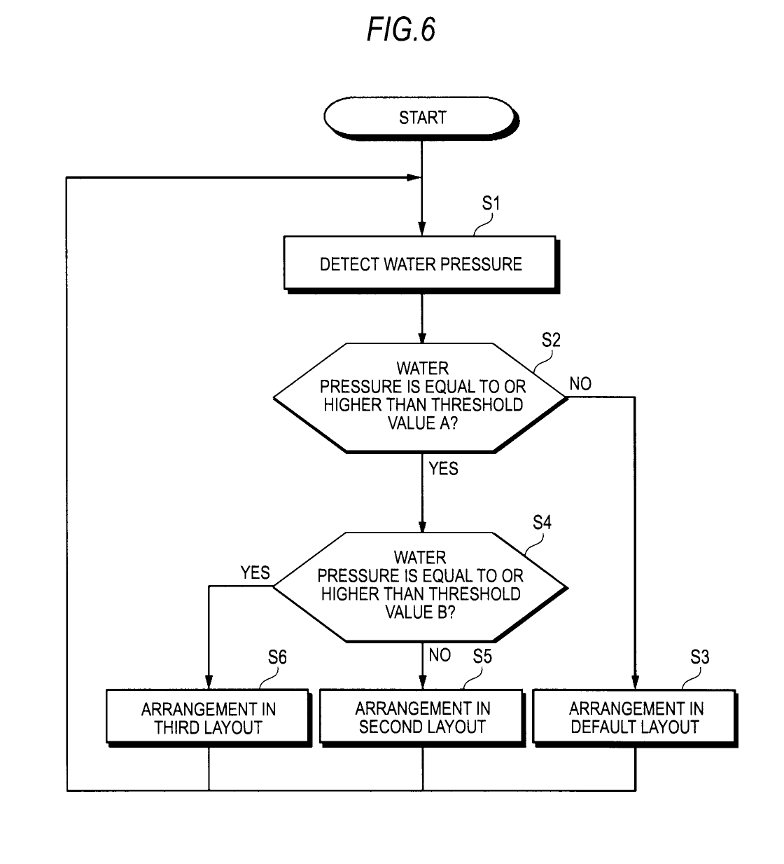

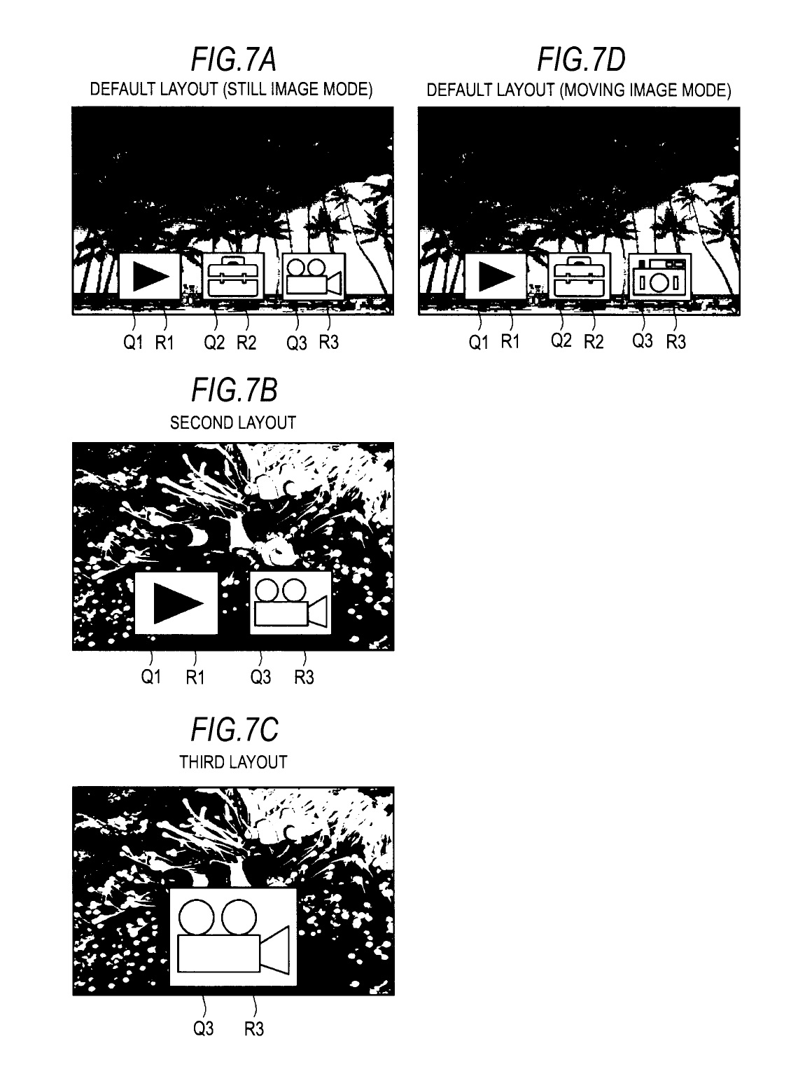

Next, processing of changing the layout of buttons and input areas at the time of imaging under water using the imaging apparatus 200 will be explained based on a flowchart of FIG. 6. FIGS. 7A to 7D are layouts of buttons displayed on the display unit 112 and input areas in the touch panel 111. FIG. 7A and FIG. 7D show layouts in default states, FIG. 7B shows a second layout and FIG. 7C shows a third layout.

In the following explanation, when water pressure detected by the pressure detection unit 120 is equal to or higher than the threshold value A as well as lower than the threshold value B which is higher than the threshold value A, the user is assumed to be in “shallow water”. When water pressure is equal to or higher than the threshold value B, the user is assumed to be in “deep water” which is a place where the water depth is deeper than “shallow water”. The following processing is performed by the layout control unit 130.

In the following explanation, the threshold value A is a threshold value to be a reference at which the layout is changed so that the number of buttons and input areas is reduced, which corresponds to the first threshold value in the embodiment. The threshold value B is a threshold value to be a reference at which the number of buttons and input areas is reduced to one, which corresponds to the second threshold value in the embodiment.

When the power of the imaging apparatus 200 is turned on, first, water pressure is detected by the pressure detection unit 120 in Step S1. Next, whether the water pressure detected by the pressure detection unit 120 is equal to or higher than the threshold value A or not is determined in Step S2. When it is determined that the water pressure is not equal to or higher than the threshold value A in Step S2, the process proceeds to Step S3 (No in Step S2), and buttons and the input areas are arranged in the default layout.

As shown in FIG. 7A, a reproduction button Q1, a setting button Q2 and a mode switching button Q3 are arranged in the default layout. Input areas R1, R2 and R3 respectively corresponding to the respective types of buttons are arranged with approximately the same sizes and at approximately the same positions.

The reproduction button Q1 is a button for starting reproduction of still images or moving images recorded in the recording unit 211. When input is performed to the input area R1 by touching the position of the reproduction button Q1 by a finger, a still image or a moving image is displayed on the display unit 112 of the touch panel unit 110. The setting button Q2 is a button for calling setting screens for performing various settings of the imaging apparatus 200. The setting screen is displayed on the display unit 112 of the touch panel unit 110. Items set in the setting screen are, for example, switching ON/OFF of image stabilization, setting of white balance and so on.

The mode switching button Q3 is a button for switching the still image mode in which still images are taken and a moving image mode in which moving images are taken at the time of imaging by the imaging apparatus 200. When input is performed to the input area R3 by adjusting the finger to touch the position of the mode switching button Q3 in the still image mode of the imaging apparatus 200, the imaging apparatus 200 is switched to the moving image mode. Conversely, when input is performed by allowing the finger to touch the mode switching button Q3 in the moving image mode of the imaging apparatus 200, the imaging apparatus 200 is switched to the still image mode. When the imaging apparatus 200 is in the still image mode, a figure indicating switching to the moving image mode, for example, a figure of a bioscope is displayed as the mode switching button Q3 as shown in FIG. 7A. When the imaging apparatus 200 is in the moving image mode, a figure indicating switching to the still image mode, for example, a figure of a camera is displayed as the mode switching button Q3 as shown in FIG. 7D.

Then, the process returns to Step S1, where the detection of water pressure is performed, and whether the water pressure is equal to or higher than the threshold value A or not is determined in Step S2. Therefore, the buttons and input areas are arranged in the default layouts except the case where water pressure is equal to or higher than the threshold A.

When it is determined that water pressure is equal to or higher than the threshold value A in Step S2, the process proceeds to Step S4 (Yes in Step S2). Next, whether water pressure is equal to or higher than the threshold value B set to be higher than the threshold value A is determined in Step S4. When it is determined that water pressure is not equal to or higher than the threshold value B in Step S4, the process proceeds to Step S5 (No in Step S4). Then, buttons and input areas are arranged in the second layout shown in FIG. 7B in Step S5. That is, the layout of buttons and input areas is changed. In the second layout shown in FIG. 7B, the reproduction button Q1 and the mode switching button Q3 as well as the input areas R1, R3 corresponding to these buttons are arranged. Additionally, the number of buttons and input areas is reduced and sizes of the reproduction button Q1 and the mode switching button Q3 as well as the input areas R1, R3 corresponding to these buttons are extended.

When the size of input areas is extended, the user can perform input by touching the position of an arbitrary button by a finger easily even when it is difficult to move arms, hands, fingers and so on smoothly by effects of water resistance under water and waves. Though there is a case where vision is blocked under water, buttons are displayed with a larger size than the default layout, therefore, positions of buttons can be viewed and confirmed easily.

There is a case where the user wears gloves at hands in scuba diving in which the user dives into water. When the user wears gloves, it is difficult to perform fine input to the touch panel 111 due to the thickness of gloves. However, the size of the input area is largely changed in the technology, therefore, it is possible to perform input easily even when the user wears gloves.

Then, the process proceeds to Step S1, where water pressure is detected. As long as it is determined that, in Step S2 and Step S4, water pressure is equal to or higher than the threshold value A as well as lower than the threshold value B, processes of Step S1, Step S2, Step S4 and Step S5 are repeated, and buttons and input areas are arranged in the second layout. The case where processes of Step S1, Step S2, Step S4 and Step S5 are repeated and buttons and input areas are arranged in the second layout corresponds to the case where the user is taking images at positions within the range of “shallow water”.

When it is determined that water pressure is not equal to or higher than the threshold value A, the process proceeds to Step S3, where buttons and input areas are displayed in the default layout. This case corresponds to the case where the user is positioned at a place at which water pressure is lower than the threshold value A, namely, the case where the user gets ashore from “shallow water” and so on.

On the other hand, when it is determined that water pressure is equal to or higher than the threshold value B in Step S4, the process proceeds to Step S6. Then, buttons and input areas are arranged in the third layout shown in FIG. 7C in Step S6. That is, the layout is changed. The case where it is determined that water pressure is equal to or higher than the threshold value B corresponds to the case where the user dives deeper from “shallow water” and moves to “deep water”.

It is more difficult to move arms, hands, fingers and so on smoothly in “deep water” as compared with in “shallow water” due to water resistance and so on. Additionally, as human beings do not breathe under water, it is necessary to use an oxygen cylinder for breathing. In other words, situations such that the oxygen cylinder is slipped off or that oxygen is depleted involve the risk of death. Therefore, the user is likely to be in psychologically unstable state in the “deep water” as compared on land or in the “shallow water”. There is a case where it is difficult to allow the finger to touch the accurate position on the touch panel 111 also by the psychological unstable state.

Accordingly, the layout of buttons and input areas is further simplified in the third layout. In the third layout, the mode switching button Q3 and the input area R3 corresponding to the button Q3 are merely arranged. The sizes of the mode switching button Q3 and the input area R3 are extended as compared with the second layout. Moreover, positions of the mode switching button Q3 and the input area R3 are adjusted so that they are arranged at approximately the center in the horizontal direction of the display screen 112A. According to the arrangement, the user can perform input more easily.

When the number of buttons and input areas is reduced to one, it is not necessary to visually check the button, therefore, the size of the input area can be made to be approximately the same as the size of the display screen 112A as described with reference to FIGS. 3A to 3C. When the size of the input area R3 is approximately the same as the size of the display screen 112A, input can be made wherever the user touches on the display screen 112A, therefore, it is also preferable that the button is not displayed. According to this, the entire display screen 112A can be used for reproduction of through images, and field angle adjustment and so on in under-water imaging can be performed without being blocked by display of buttons. In order to prevent the user from not knowing which processing will be performed by the input when the button is not displayed, the button can be displayed in a half-transparent state. It is also preferable that the button is displayed at a corner of the display screen 112A with a small size.

Then, the process returns to Step S1 and water pressure is detected. As long as water pressure is determined to be equal to or higher than the threshold value A in Step S2 as well as water pressure is determined to be equal or higher than the threshold value B in Step S4, buttons and input areas are kept on being arranged in the third layout (Yes in Step S4).

When it is determined that water pressure is not equal to or higher than the threshold value B, the process proceeds to Step S5 (No in Step S4). This case corresponds to a case where the user moves from “deep water” to “shallow water”. In this case, buttons and input areas are arranged in the second layout shown in FIG. 7B in Step S5. Then, determination of comparison between water pressure and the threshold values A or the threshold value B is performed in Step 2 and Step S4 in the state in which buttons and input areas are arranged in the second layout. After that, the layout change of buttons and input areas is performed in Step S3, Step S5 or Step S6 based on the determination result.

That is, buttons and input areas are arranged in the default layout when water pressure is lower than the threshold value A. When water pressure is equal to or higher than the threshold value A as well as it is lower than the threshold value B, buttons and input areas are arranged in the second layout. Moreover, when water pressure is equal to or higher than the threshold value B, buttons and input areas are arranged in the third layout. As described above, the layout of buttons and input areas is changed so as to corresponding to the magnitude of water pressure detected by the pressure detection unit 120 in the technology.

The threshold value A and the threshold value B can be set to various values. The threshold value B is to be used when the number of buttons and input areas is reduced to one. Therefore, it is also preferable that plural threshold values are further set between the threshold value A and the threshold value B to thereby change the layout in accordance with water pressure more frequently.

In the case of reducing the number of buttons and input areas by changing the layout, it is preferable that user can select and set which functional buttons and input areas of the imaging apparatus 200 are left and which functional buttons and input areas are cut. According to the setting, it is possible to construct the user interface suitable to one's taste by users more individually.

It is generally conceivable that there is little chance to reproduce and see still images and moving imaged recorded in the recording unit 211 at the time of imaging under water. It is also conceivable that there is little chance to change various settings of the imaging apparatus 200. On the other hand, there are both cases of taking still images and imaging moving images also at the time of taking images under water, therefore, there are many chances to change the mode. Accordingly, the mode switching button Q3 used for switching between the still image mode and the moving image mode is left as the last one button. However, the reproduction button Q1 or the setting button Q2 can be left as the last one button. Additionally, the reproduction button, the setting button and the mode switching button are cited as examples, and buttons and input areas corresponding to other functions can be applied.

### <2. Second Embodiment>

Hereinafter, a second embodiment of the present disclosure will be explained. As the configurations of the user interface device 100 and the imaging apparatus 200 applying the user interface device 100 are the same as the first embodiment, the explanation thereof is omitted.

The case where imaging is performed under water using the imaging apparatus 200 has been explained in the first embodiment, however, the situations in which the technology can be used are not limited to under water. The technology can be also applied to, for example, at high mountains in which air pressure is reduced as the altitude becomes higher.

At high mountains where the altitude is high, the air pressure is reduced and the air becomes thinner as the altitude becomes higher. Breathing becomes difficult accordingly. There is also a danger of altitude disease. Therefore, the user is likely to be in psychologically unstable state in the same manner as under water. There occurs a case where it is difficult to allow the finger and so on to touch the accurate position on the touch panel 111 due to the psychological instability. There is also a case where it is difficult to allow the finger and so on to touch the accurate position on the touch panel 111 as the user wishes because vision is blocked by fog or snow at high mountains. Accordingly, the air pressure is detected by the pressure detection unit 120 and the layout of buttons and input areas is changed based on the comparison result between the detected air pressure and threshold values.

### [2-1. Operation of the User Interface Device in the Imaging Device]

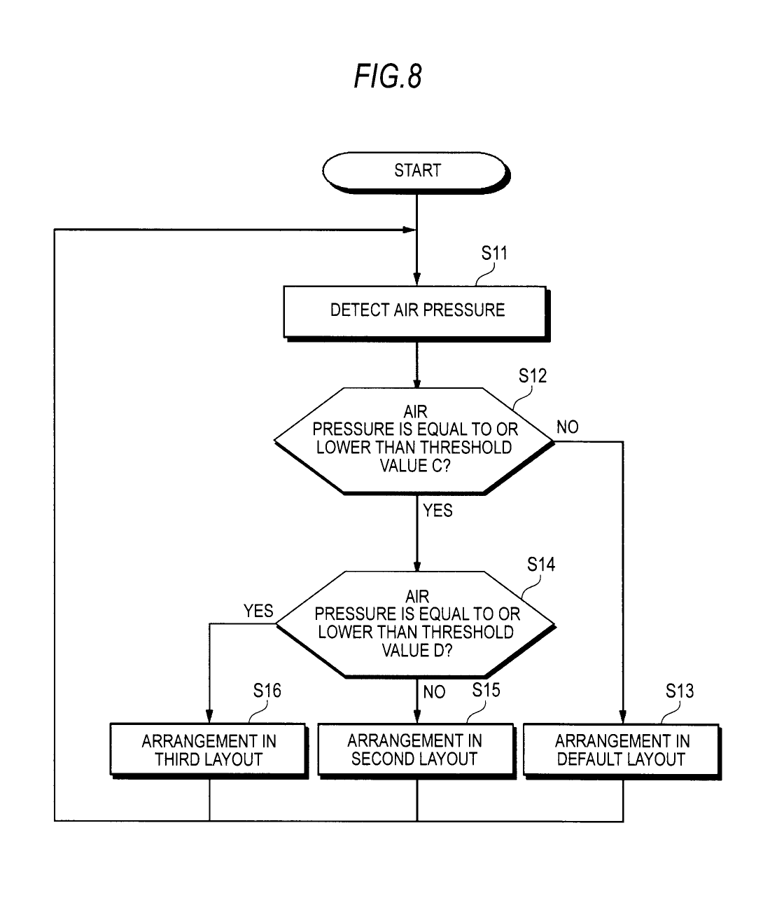

Hereinafter, processing of changing the layout of buttons and input areas in imaging at high mountains using the imaging apparatus 200 to which the user interface device 100 is applied will be explained with reference to a flowchart of FIG. 8. Types of the layout of buttons and input areas are the same as in FIGS. 7A to 7D, therefore, explanation will be made with reference to FIGS. 7A to 7D. The higher the altitude becomes, the lower the air pressure becomes, therefore, whether the air pressure is “equal to or lower” than threshold values or not is determined and a series of processing is performed in the second embodiment.

In the following explanation, a threshold value C is a threshold value to be a reference at which processing of changing the layout is performed so that the number of buttons and input areas is reduced, which corresponds to a third threshold in the embodiment. A threshold value D is a threshold value at which processing of changing the layout is performed so that the number of buttons and input areas is reduced to one, which corresponds to a fourth threshold in the embodiment.

When the user turns on the power of the imaging apparatus 200, first, air pressure is detected by the pressure detection unit 120 in Step S11. Next, whether the air pressure detected by the pressure detection unit 120 is equal to or lower than the threshold value C or not is determined in Step S12. When it is determined that the air pressure is not lower than the threshold value C, the process proceeds to Step S13 (No in Step S12) and buttons and input areas are arranged in the default layout. The default layout is the one shown in FIG. 7A. For example, when the user performs imaging on flatland, buttons and input areas are arranged in the default layout shown in FIG. 7A. Then, the process returns to Step S11, and detection of air pressure is performed in Step S11 as well as comparison between the air pressure and the threshold value is made in Step S12.

As long as it is determined that the air pressure is not equal to or lower than the threshold value C, the process proceeds to Step S13 (No in Step S12) and buttons and input areas are kept on being arranged in the default layout.

Then, when it is determined that the air pressure is equal to or lower than the threshold C, the process proceeds to Step S14 (Yes in Step S12). Next, whether the pressure is equal to or lower than the threshold value D which is set to be lower than the threshold C or not is determined in Step S14. When it is determined that the pressure is not equal to or lower than the threshold D in Step S14, the process proceeds to Step S15 (No in Step S14). Then, buttons and input areas are arranged in the second layout shown in FIG. 7B in Step S15. That is, the layout of buttons and input areas is changed. This corresponds to a state in which the user performs imaging at a place of high altitude. In the second layout shown in FIG. 7B, the reproduction button Q1 and the mode switching button Q3 as well as input areas R1, R3 corresponding to these buttons are arranged, and the sizes of these buttons Q1, Q3 and the input areas R1, R3 are extended.

Then, the process proceeds to Step S11, where air pressure is detected. As long as the air pressure is equal to or lower than the threshold value C as well as higher than the threshold value D in the determination of Step S12 and Step S14, buttons and input areas are kept on being arranged in the second layout.

Then, when it is determined that the air pressure is not equal to or lower than the threshold value C in Step S12, the process proceeds to Step S13, and buttons and input areas are displayed in the default layout. This corresponds to a case where the user moves to a place where air pressure is higher than the threshold value C, namely, from the high mountain to the flatland and so on.

On the other hand, when it is determined that air pressure is equal to or lower than the threshold value D in Step S14, the process proceeds to Step S16 (Yes in Step S14). Then, buttons and input areas are arranged in the third layout shown in FIG. 7C. That is, the layout is changed. The case where air pressure is determined to be equal to or lower than the threshold value D corresponds to a case where the user climbs up to a place of higher altitude. In the third layout, the mode switching button Q3 and the input area R3 are merely arranged and sizes thereof are further extended. Additionally, the mode switching button Q3 and the input area R3 are arranged at approximately the center in the horizontal direction of the display screen 112A.

Then, the process returns to Step S11. As long as air pressure is determined to be equal to or lower than the threshold value C in Step S12 as well as air pressure is equal to or lower than the threshold value D in Step S14, buttons and input areas are kept on being arranged in the third layout (Yes in Step S14).

Then, when it is determined that the pressure is not equal to or lower than the threshold value D in Step S14, the process proceeds to Step S15 (No in Step S14). This corresponds to a case where the user moves to a place of lower altitude in the high mountain. In this case, buttons and input areas are arranged in the second layout shown by FIG. 7B in Step S15. Then, comparison determination is made between air pressure and the threshold value C as well as between air pressure and the threshold value D in the state in which buttons and input areas are arranged in the second layout. The layout of buttons and input areas is changed based on the determination result in Step S13, Step S15 or Step S16.

In the second embodiment, the layout is changed so that the arrangement of buttons and input areas is simplified as air pressure becomes lower. Accordingly, it is possible to allow the finger to touch the touch panel 111 and perform the input easily even when it is difficult to move arms, hands, fingers and so on smoothly such as in the psychologically unstable state, or in the state in which vision is not good and so on. Additionally, it is normal that the user wears gloves in climbing to a snow-capped mountain and so on. As the layout is changed so that the size of input areas is extended, the input can be performed easily even when the user wears gloves.

As described above, the point in which the size of the input area is made to be approximately the same as the size of the display screen 112A as shown in FIG. 3A, the point in which the button is not displayed, the point in which the button is displayed in the half-transparent state as shown in FIG. 3B and the point in which the button is displayed at a corner of the display screen 112A with the small size are the same as the first embodiment.

### <3. Modification Example>

The embodiments of the present disclosure have been explained as the above, however, the present disclosure is not limited to the above embodiments and can be variously modified based on technical ideas of the present disclosure. In the case where the imaging apparatus is used under water as in the above explanation and in the case where the input is performed in the state of wearing gloves, the resistance-film type touch panel is preferably used, however, various touch panels such as the capacitance type or supersonic type and so on can be used in addition to the resistance-film type touch panel.

Additionally, the case where the user interface device is applied to the digital camera capable of taking still images and moving images has been explained as the above, however, the user interface device can be also applied to a digital camera capable of taking only still images and a digital camera capable of taking only moving images.

Furthermore, it is also preferable to change the number, the arrangement and the size of guide icons of hardware buttons displayed on the display unit, not limited to the case of changing the number, the arrangement and the size of buttons and input areas corresponding to the buttons on the touch panel.

The present disclosure contains subject matter related to that disclosed in Japanese Priority Patent Application JP 2010-165949 filed in the Japan Patent Office on Jul. 23, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A user interface device comprising:
a display unit on which plural buttons are displayed;
a touch panel integrally formed with the display unit and detecting input in plural input areas corresponding to respective display areas of the plural buttons;
a pressure detection means for detecting water pressure; and
a layout control means for changing a layout of the buttons and the input areas so as to reduce the number of the buttons and the input areas corresponding to the buttons in accordance with detected magnitude of water pressure when the water pressure detected by the pressure detection means is equal to or higher than a previously set threshold value.

2. The user interface device according to claim 1,
wherein a first threshold value and a second threshold value higher than the first threshold value are set as the threshold values, and
the layout control means changes the layout of the buttons and the input areas so that the number of the buttons and input areas corresponding to the buttons is reduced to one when the water pressure is equal to or higher than the second threshold value.

3. A user interface device comprising:
a display unit on which plural buttons are displayed;
a touch panel integrally formed with the display unit and detecting input in plural input areas corresponding to respective display areas of the plural buttons;
a pressure detection means for detecting air pressure; and
a layout control means for changing a layout of the buttons and the input areas so as to reduce the number of the buttons and the input areas corresponding to the buttons in accordance with detected magnitude of air pressure when the air pressure detected by the pressure detection means is equal to or lower than a previously set threshold value.

4. The user interface device according to claim 3,
wherein a third threshold value and a fourth threshold value higher than the third threshold value are set as the threshold values, and
the layout control means changes the layout of the buttons and the input areas so that the number of the buttons and input areas corresponding to the buttons is reduced to one when the air pressure is equal to or lower than the fourth threshold value.

5. The user interface device according to claim 1,
wherein the layout control means further changes the layout so as to extend sizes of the buttons and the input areas corresponding to the buttons.

6. The user interface device according to claim 2,
wherein the layout control means changes the layout so that the size of the input area is made to be approximately the same as the size of a display screen in the display unit when the number of buttons and the input areas corresponding to the buttons is reduced to one.

7. The user interface device according to claim 6,
wherein the layout control means changes the layout of the button so that the button is not displayed on the display unit.

8. The user interface device according to claim 6,
wherein the layout control means changes the layout so that the button is displayed on the display unit in a half-transparent state.

9. The user interface device according to claim 2,
wherein the layout control means changes the layout so that the button and the input area corresponding to the button is positioned at approximately the center of the display screen of the display unit when the number of buttons and the input areas corresponding to the buttons is reduced to one.

10. A user interface method comprising:
displaying plural buttons on a display unit;
setting positions of the plural buttons displayed on the display unit as well as setting plural areas corresponding to respective display areas of the plural buttons as input areas on a touch panel integrally formed with the display unit and detecting input;
detecting water pressure; and
changing a layout of the buttons and the input areas so as to reduce the number of the buttons and the input areas corresponding to the buttons in accordance with detected magnitude of water pressure when the water pressure detected by the step of detecting pressure is equal to or higher than a previously set threshold value.

11. A user interface method comprising:
displaying plural buttons on a display unit;
setting positions of the plural buttons displayed on the display unit as well as setting plural areas corresponding to respective display areas of the plural buttons as input areas on a touch panel integrally formed with the display unit and detecting input;
detecting air pressure;
changing a layout of the buttons and the input areas so as to reduce the number of the buttons and the input areas corresponding to the buttons in accordance with detected magnitude of air pressure when the air pressure detected by the step of detecting pressure is equal to or lower than a previously set threshold value.
